(19) United States
(12) Patent Application Publication
(10) Pub. No.: US 2001/0024284 A1
(43) Pub. Date: Sep. 27, 2001

(54) Test printing method, information processing apparatus, and printing system

(76) Inventor: Takashi Kise, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/774,037

(22) Filed: Jan. 31, 2001

(30) Foreign Application Priority Data
Feb. 1, 2000 (JP) 2000-24400

(51) Int. Cl. B41B 1/00

(52) U.S. Cl. 358/1.1

(57) ABSTRACT

In test printing for a printing system which enables a comparison test pattern to be simultaneously printed, printing of the comparison test pattern is easily set. More specifically, when a corrected test pattern is to be printed as a test pattern (step S101), it is determined whether or not a switch for allowing a user to set test printing to print only the corrected test pattern has been activated (step S102). If the switch has been deactivated, a non-corrected test pattern is printed (step S103). This enables selection of either printing of both the corrected and non-corrected test patterns or printing of only the corrected test pattern.

This application is based on Patent Application No. 2000-24400 filed Feb. 1, 2000 in Japan, the content of which is incorporated hereinto by reference.

### BACKGROUND OF THE INVENTION

1. Field of the Invention

The present invention is related to a test printing method, an information processing apparatus, and a printing system, and particularly to test printing executed in connection with a calibration or the like for printing apparatuses such as copy machines and printers to print a test pattern for comparison in order to check an effect of the calibration on image processing such as a γ correction process.

2. Description of the Related Art

A printing apparatus may have its printing characteristics changed due to conditions of an environment, in which the apparatus is used, such as a temperature and humidity of the environment. In addition to these environmental conditions, use of the printing apparatus for a certain period of time may change its printing characteristics. For example, in the printing apparatus using an electro-photographic method, this change occurs because a photosensitive characteristic or the like of a photosensitive drum is changed due to the environmental conditions or an age changing resulting from the use, causing changes in the printing characteristics such as gradation, which are observed in printed images or the like. It is also known that in an ink jet printing apparatus, these changes in printing characteristics are caused, for example, by changes in an ejection characteristic of a head for ejecting inks.

On the other hand, it is conventionally known that to correct these changes in printing characteristics, for example, contents of a γ correction table for image processing are changed to calibrate the printing apparatus to maintain appropriate printing characteristics. In addition, with respect to manners in which such calibration is executed, the calibration is not only executed to correct changes in the printing characteristics of individual printing apparatuses but may also be executed for an information processing system using a plurality of printing apparatuses, to reduce differences in printing characteristics among the printing apparatuses if such differences pose problems.

Such calibration is essentially executed based on a user's instruction input. For example, upon determining that printed images do not have gradation as desired by the user, the user instructs calibration to be executed on an operation screen displayed on the printing apparatus or a personal computer (hereafter referred to as a “PC”). In general, based on this instruction, the printing apparatus to be calibrated first prints a patch with predetermined gradation values. A measuring instrument such as a densitometer or a scanner is then used to read densities to obtain calibration data based on the results of this read, the data indicating, for example, contents of the above described γ correction table to be renewed.

In this connection, test printing may be executed to check effects of an image correcting process section such as the γ correction table, which is obtained as a result from the above calibration, on the printed images. In one form of the test printing, test patterns are printed before and after the image correction is carried out to compare the test pattern printed based on test pattern data of corrected image with that printed based on test pattern data of non-corrected image, thereby checking the effects of the image processing. The test printing is not only executed for the calibration but also executed in editing calibration information or the like, for example, in changing the contents of the γ correction table obtained through the calibration, in order to check the effects of this change.

The execution of the above described conventional test printing, however, must be improved particularly in terms of a user interface. For example, it is troublesome for the user to switch between printing of a test pattern of corrected image and printing of a test pattern of non-corrected image as required.

### SUMMARY OF THE INVENTION

It is an object of the present invention to provide a test printing method, an information processing apparatus, and a printing system wherein in test printing for a printing system which enables a comparison test pattern to be printed together with a test pattern, printing of the comparison test pattern can be easily set.

In a first aspect of the present invention, there is provided a test printing method capable of printing a test pattern and a comparison test pattern with which the test pattern is compared, the method comprising the steps of:

printing the test pattern;

judging whether or not printing the comparison test pattern; and

when the judgement is what to print the comparison test pattern, printing the comparison test pattern.

Preferably, the step of judging may judge whether or not printing the comparison test pattern based on a state of an input by an operation of a user.

In an another aspect of the present invention, there is provided an information processing apparatus capable of causing a printing apparatus to print a test pattern and a comparison test pattern with which the test pattern is compared, the information processing apparatus executing a process comprising the steps of:

causing the printing apparatus to print the test pattern;

judging whether or not printing the comparison test pattern; and

when the judgement is what to print the comparison test pattern, causing the printing apparatus to print the comparison test pattern.

Preferably, the step of judging may judge whether or not printing the comparison test pattern based on a state of an input by an operation of a user through the user inter face.

In a further aspect of the present invention, there is provided a printing system capable of printing a test pattern and a comparison test pattern with which the test pattern is compared when executing a test printing, wherein a process including the steps of:

printing the test pattern;

judging whether or not printing the comparison test pattern; and

when the judgement is what to print the comparison test pattern, printing the comparison test pattern is executed.

Preferably, the step of judging may judge whether or not printing the comparison test pattern based on a state of an input by an operation of a user through the user inter face.

According to the above configuration which is capable of printing a test pattern and a comparison test pattern therefor, when the test pattern is to be printed, it can be judged whether or not to also print the comparison test pattern, thereby making it possible to determine to print the comparison test pattern or determine not to print it depending on the result of the judgement. Accordingly, if the above judgement is made depending on a user's operation input, it enables the user to set the test printing to print either only the test pattern or both the test pattern and the comparison test pattern therefor.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a block diagram showing a configuration of a printing system according to one embodiment of the present invention;

FIG. 2 is a flow chart showing a basic calibration process according to one embodiment of the present invention;

FIG. 3 is a diagram showing a relationship between FIGS. 3A and 3B; FIGS. 3A and 3B are diagrams schematically showing patch data used for the calibration, respectively;

FIG. 4 is diagram showing a relationship between arrangement positions of data sections of the patch data and gradation values;

FIG. 5 is a flow chart showing a brightness-density conversion table creating process used in scanning for the calibration shown in FIG. 2;

FIGS. 6A, 6B, and 6C are graphs useful in explaining generation of a calibration table according to one embodiment of the present invention;

FIG. 7 is a flow chart showing a process executed by a printer in connection with a calibration according to one embodiment of the present invention;

FIG. 8 is a flow chart useful in explaining a part of the above printer process which relates to normal printing;

FIG. 9 is a diagram showing a transition of process executed by an application in connection with the calibration according to one embodiment of the present invention;

FIG. 10 is a view showing an example of a screen displayed by the above application;

FIG. 11 is a view showing an example of display in a calibration process for a scanner according to one embodiment of the present invention;

FIG. 12 is a block diagram particularly showing a configuration for test printing in a printing system according to one embodiment of the present invention;

FIG. 13 is a flow chart showing a process for the test printing according to a first embodiment of the present invention;

FIG. 14 is a view showing a display screen of a user interface displayed while the above test printing is being executed;

FIG. 15 is a flow chart showing a process for test printing according to a second embodiment of the present invention; and

FIG. 16 is a view showing a display screen of the user interface displayed while test printing according to a third embodiment of the present invention is being executed.

### DETAILED DESCRIPTION OF PREFERRED EMBODIMENTS

Embodiments of the present invention will be described below in detail with reference to the drawings.

<First Embodiment>

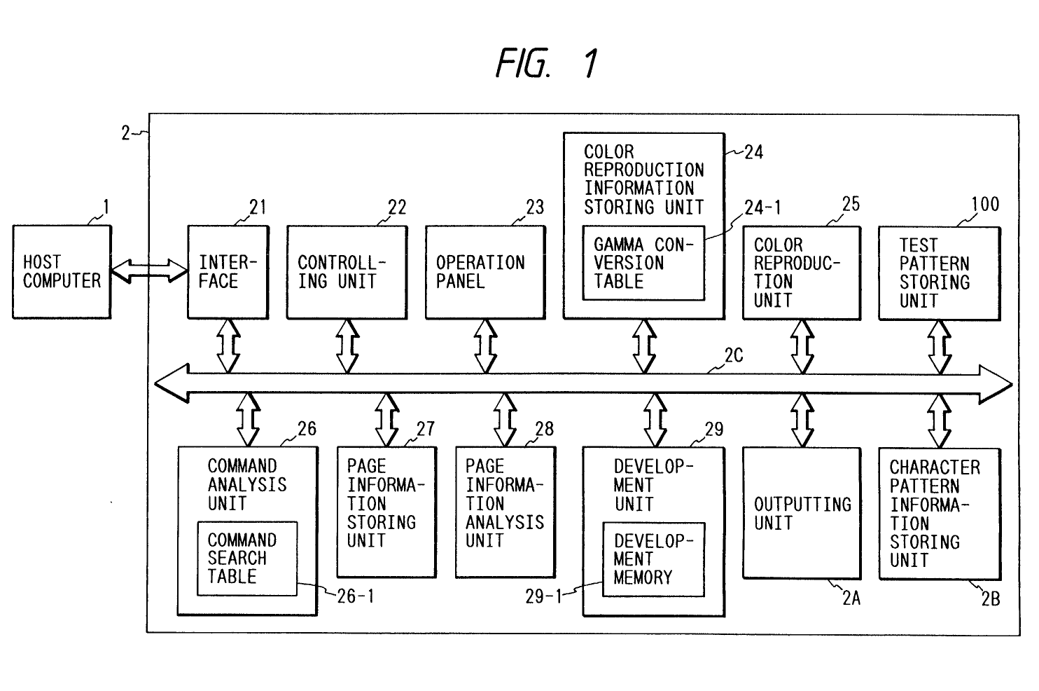

FIG. 1 is a block diagram showing a configuration of a printing system according to one embodiment of the present invention.

The printing system of this embodiment is configured to comprise a server PC1, a client PC4, and a printer 2 which are connected together via a network 5. This system also comprises a plurality of other clients PC4 and printers 2 (not shown) connected thereto. A user can normally use this printing system to cause documents, images, or the like processed by various applications in the clients PC4 to be printed and select ones of the plurality of printers 2 connected to the network 5 to execute printing out from the selected printer.

Before explaining a manner of test printing in the present printing system, a calibration in the present system, which constitutes a premise for the test printing, will be described with reference to FIGS. 1 to 11.

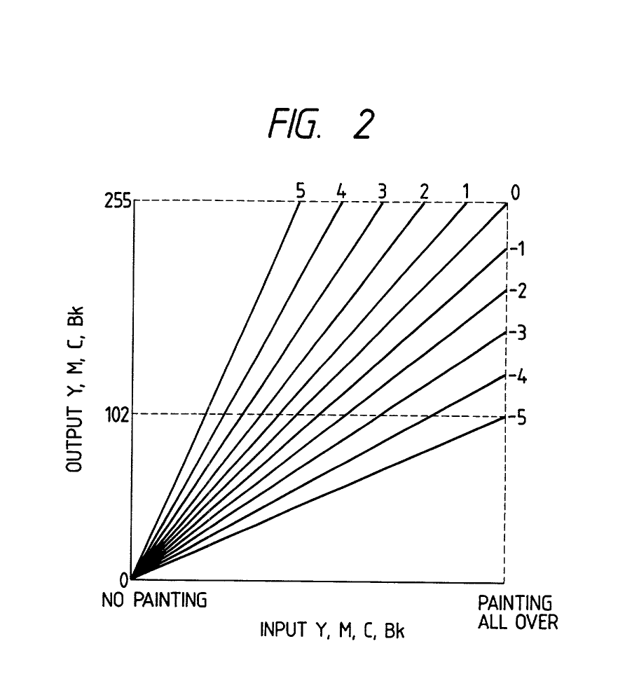

As shown in FIG. 1, the server PC1 supplies various data such as files depending on requests made by the clients PC4 connected to the network. In addition, in this embodiment, the server PC1 executes processes such as generation of a calibration table for the printer 2, which will be described later as referring to FIG. 2, or the like and thus has software programs therefor installed therein.

Further, the server PC 1 is provided with a scanner 3 connected thereto. The scanner 3 can use a scanner driver in the server PC1 to read originals and then input read data to the server PC1. The read original data are processed by the server PC1 or the client PC4 as documents, images, or the like. The scanner 3 is also used to read densities of patches when the printer 2 is calibrated. Further, in this embodiment, in connection with this calibration, the scanner 3 is also calibrated, and the server PC1 correspondingly has a scanner calibration data storage section 11 for this purpose.

With the client PC4, the user can use various applications to execute corresponding processes, and for printing, generate and edit print data such as documents, images or the like, and instruct the printer 2 to execute printing.

The plurality of printers are connected to the network 5 as described above and are each capable of executing printing in response to an instruction from any of the plurality of clients PC 4 connected to the network 5. The printers 2 of this embodiment use an electrophotographic system of a laser beam. The printers 2 each has a calibration data storage section 21 arranged therein to store correction function data for its image correction process. That is, in the printing system of this embodiment, each printer 2 is to be calibrated to appropriately maintain printing characteristics and the server PC1 downloads the correction function data, in this embodiment, a γ correction table generated through the calibration process into the printer 2 as calibration data, so that the table is stored in the storage section 21. When the calibration is executed, the scanner 3 is also calibrated as described above. The printer 2 can then use the correction function data obtained as described above to subject image data to a γ conversion to generate print data.

In this embodiment, the printers use laser beams system, but the application of the present invention is of course not limited to this aspect. For example, other systems such as the ink jet system can also be used. Additionally, the γ correction has been taken as an image correction process by way of example, the present invention is of course not limited to this aspect.

As described above, in this embodiment, the calibration is carried out by the server PC1 in response to an instruction from the user, while printing is executed by the corresponding client PC4 and the selected printer 2 in response to an instruction from the user.

The calibration in this embodiment based on the above configuration will be described below.

FIG. 2 is a flow chart showing a process procedure for generating correction function data and the like, which are executed by the server PC1.

First, at step S21, one of the printers is selected for calibration and patch data is outputted and an instruction is given, to the selected printer via the network 5, so that the printer prints a patch. The printer is selected in accordance with network management rules, but description of these rules is omitted.

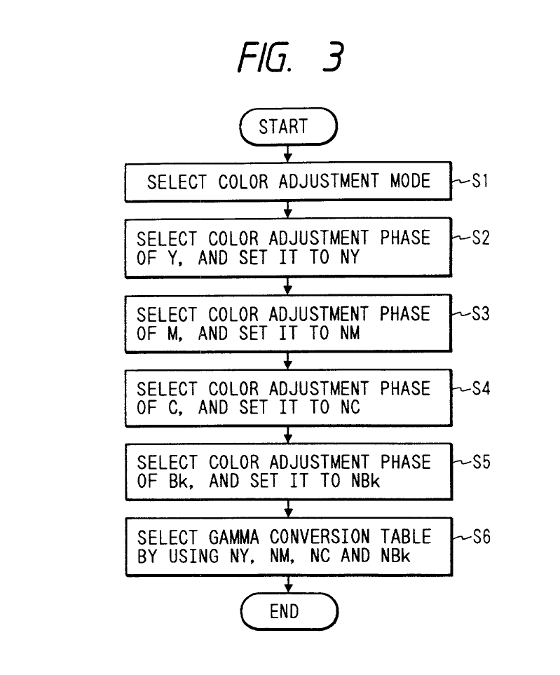

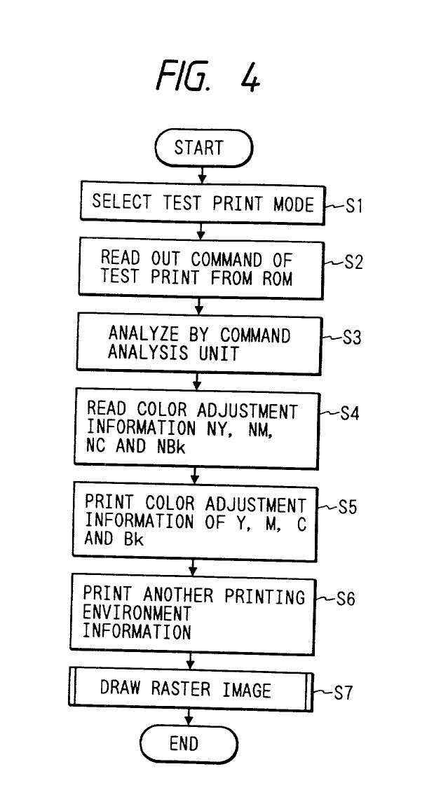

FIGS. 3A and 3B are schematic diagrams respectively showing an example of the above described patch data. As shown in these figures, the patch data in this embodiment can form the patch composed of vertical 32 sections×horizontal 32 sections=1,024 sections within one page of sheet on which the patch is printed. The sections each correspond to one of magenta, cyan, yellow, and black corresponding to the color of each toner for the printer 2, and a number shown in each section indicates information on an arrangement position of that section. This number also corresponds to gradation data required to print the corresponding section as shown in FIG. 4. For example, an arrangement position “0” has a gradation value of “0”, an arrangement position “32” has a gradation value of “128”, and an arrangement position “63” has a gradation value of “255”. The gradation value in this embodiment has a value between 0 and 255 as 8-bit data for each color as shown in FIG. 4. If, however, the data for each color are represented with a different number of bits, the gradation value corresponding to the arrangement position in FIG. 4 may be shifted depending on this number of bits. In the illustrated patch, those sections corresponding to the respective colors that are shown with the same number are disposed at the same position in the vertical direction of the patch and contiguously in the horizontal direction to form one block having the same gradation value.

The patch of this embodiment shown in FIG. 3 is divided into highlight blocks of a relatively low density for which the number indicating the arrangement position is between 0 and 31 (the gradation value is between 0 and 124) and shadow blocks of a relatively high density for which the same number is 33, 35, 37, . . . 59, 61, or 63 (the gradation value is 132, 140, 148, . . . 236, 244, or 255). The highlight and shadow blocks are distributed all over the patch in its vertical direction (32 blocks) and are alternately and repeatedly located in the horizontal direction. In this case, as is apparent from the figure, for the shadow blocks, the same block pattern is repeated twice in the vertical direction. In addition, for the highlight blocks, the gradation value for the location of each block varies periodically in a pattern wherein the blocks are repeated in the horizontal direction as described above.

In other words, the patch in this embodiment has the highlight blocks which correspond to 32 levels of the gradation values and are arranged at four locations, and the shadow blocks which correspond to 16 levels of the gradation values and are arranged at eight locations. A difference exists in the number of gradation values between the highlight and shadow blocks because a highlight portion, which has a lower density, requires information on finer changes in density, that is, finer changes in printing characteristics. Additionally, a number of patterns arranged for the shadow blocks is greater than that of highlight blocks because the scanner tends to read a shadow portion more variably than it reads the highlight portion. Such a patch configuration enables an accurate calibration with fewer patch sections.

In the above description, the patch data are supplied to the printer 2 from the server PC 1 via the network 5, but the present invention is not limited to this aspect. For example, the printer 2 may have information required to organize patch data of the format shown in FIG. 3, so as to generate the patch data based on this information, in response to an instruction from the server PC1. The information held by the printer 2 depends on a command system held by the printer 2, but description thereof is omitted.

Once the printing of the patch at step S21 (FIG. 2) as described above is completed, a patch density is measured using the scanner 3, which is used as if a densitometer is used.

More specifically, the user sets a sheet with the above described patch printed thereon, in the scanner 3 and causes the scanner 3 to execute reading using a scanner driver on the server PC1. The scanner 3 inputs the density of each section of the patch as a brightness signal R, G, B, which is transferred to the server PC1. Upon receiving these input values, based on the arrangement information for each block, the server PC1 calculates, for the highlight blocks, an average of the input values for the four sections for which the patch data have the same gradation value for each of the cyan (C), magenta (M), yellow (Y), and black (K), while calculating, for the shadow blocks, an average of the input values for the eight sections having the same gradation value for each color. As a result, R, G, B signal values are obtained for each color, that is, C, M, Y or K, the signal values corresponding to 48 levels of the gradation values for the patch.

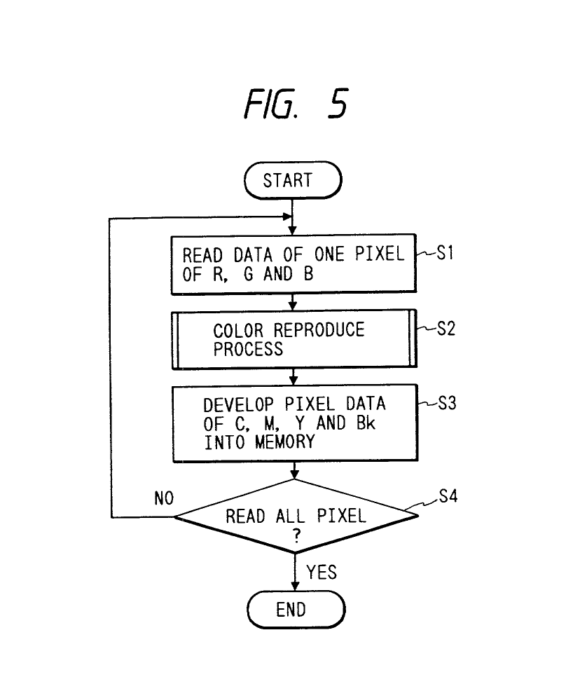

Further, these R, G, B signal values are converted into density signal values using a brightness-density conversion table that has already undergone a scanner calibration as described later in FIG. 5. Then, the current output density characteristic (the printing characteristic in this embodiment) is finally obtained which comprises 48 density values for each color, that is, C, M, Y, or K.

The generation of the brightness-density conversion table in connection with the scanner 3, that is, the scanner calibration for the scanner of this embodiment, which is used as if a densitometer is used, will be described with reference to FIG. 5.

The brightness-density conversion table is generated for each of C, M, Y, and K. The table is configured so that when reference x denotes a value input from the scanner for a certain block within a patch for the scanner calibration and reference y denotes the density of that block correspondingly obtained from density data of the patch, then an input x results in an output y. Thus, if a scanner input characteristic changes or a different type of scanner is used, the scanner calibration is executed to obtain a brightness-density conversion relationship.

In this embodiment, in measuring the patch density, R data generated by the scanner are used to measure the density of the C patch, G data are used to measure the density of the M patch, B data are used to measure the density of the Y patch, and G data are used to measure the density of the K patch. Thus, the brightness-density conversion table is generated for each of C, M, Y and K based on the R, G, and B brightness data values corresponding to the respective C, M, Y, and K patches and on density information (density data) loaded as described later.

FIG. 5 is a flow chart showing a procedure of a process for generating the brightness-density conversion table. First, at step S51, the scanner 3 to be calibrated is used to read a predetermined scanner calibration patch to obtain brightness signal values. This predetermined patch is arranged similarly to that shown in FIG. 3, is printed beforehand by means of offset printing or the like, and is different from the one printed at the above described step S21. Of course, the configuration of this scanner calibration patch need not necessarily be similar to that shown in FIG. 3.

At step S52, results of the measurements at step S51 are displayed as shown in FIG. 11. An input range of the scanner must be efficiently used in order to accurately measure the density using the scanner. This is because if the measurement results show the same output value over a certain range as in the <bad example> shown in FIG. 11, this range cannot be effectively corrected. Thus, accurate measurements of the density using the scanner must have results such as those in the <good example> shown in FIG. 11.

If the results of the measurement of each of C, M, Y and K displayed in the left of FIG. 11 indicate the same output level over a certain input range as in the bad example shown in the right of the figure, the user is advised to again cause the processing at step S51 to be executed.

If the reading results are such as those in the <bad example>, they may be improved by changing scanner reading conditions, for example, resolution, color processing conditions, or color matching conditions.

Next, at step S53, the density data for each of C, M, Y, and K are loaded which are obtained by previously measuring the scanner calibration patch used at step S51 using a separately provided densitometer or the like. The density data are stored in the server PC1 in advance after the measurements. That is, the scanner calibration patch and the density data stored in the server PC1 are associated with each other so as to have a fixed relationship so that calibration at step S54, shown next, can be based on this relationship.

At the next step S54, the brightness-density conversion table used at the above described step S22 (FIG. 2) is generated based on the relationship between the brightness signals R, G and B read at the above described step S51 and the density signals C, M, Y and K loaded at step S53. This process corresponds to the calibration of the scanner 3.

The scanner 3 executes scanning (reading) via the scanner driver configured on the server PC 1 as described above; the scanner driver is also used to set the scan resolution, color processing conditions, or color matching conditions or to designate the input area.

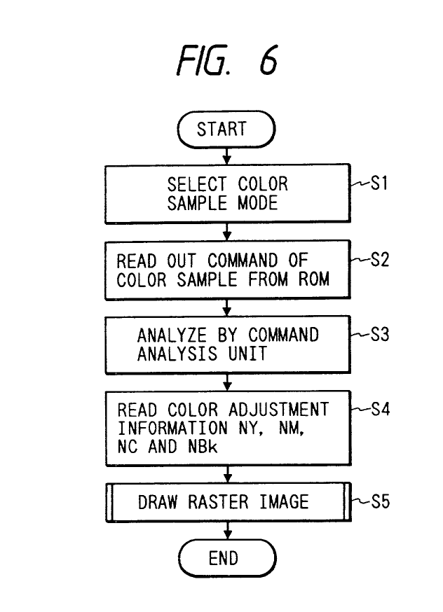

Once the reading (step S22) by the scanner 3, which is calibrated as described above, has been completed, the server PC 1 generates a calibration-based correction function at step S23. FIGS. 6A, 6B, and 6C are graphs useful in explaining this table generation.

FIG. 6A is a graph showing an output density characteristic of the printer 2, which is obtained through the reading at the above described step S22. This figure shows the output density characteristic for only one color to simplify the illustration. Similarly, a table creating process will be described for only one color.

The output density characteristic shown in FIG. 6A is obtained by means of the 48 levels of density values obtained at step S22 and an interpolation operation using these values. In this embodiment, a printer showing such a characteristic is subjected to the calibration comprising a process of renewing the contents of a γ correction table used to generate print data for the printer, based on the output density characteristic. Specifically, a combination of the γ correction table with the output density characteristic are made to have contents such as those shown in FIG. 6B so as to have a linear input-output relationship as shown in FIG. 6C. That is, the contents of the table must have the input-output relationship shown in FIG. 6B, which constitutes a reverse function for the input-output function shown in FIG. 6A.

After the correction function has been generated as calibration data as described above, the server PC 1 downloads the calibration data into the printer 2 via the network 5 at step S24.

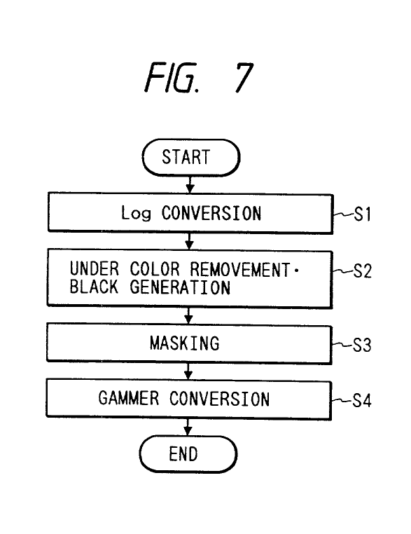

A process procedure used by the printer 2 to download the calibration data will be explained with reference to FIG. 7.

First, it is determined at step S71 whether or not data have been received. When it is determined that the data have been received, the data are analyzed at step S72. When the result of this analysis indicates that the calibration data have been downloaded (step S73), the correction function data as the calibration data are stored (registered) in the calibration data storage section 21 at step S74 as described above. The storage of the correction function data, specifically, the γ correction table corresponds to the renewal of the γ correction table or calibration.

On the other hand, if it is determined at step S73 that the data other than the calibration data have been downloaded, a corresponding process is executed at step S75.

The process shown in FIG. 7 is executed when not only the calibration data but also certain general data different from the calibration data have been downloaded from the server PC1 or the client PC4 as described above. For example, even when print data are downloaded into the printer 2 for printing, the print data are downloaded in accordance with the procedure shown in FIG. 7. That is, if it is determined at step S73 that the print data have been downloaded, analysis of the print data, organization of a page layout, image processing, and a printing process based on these processes are executed.

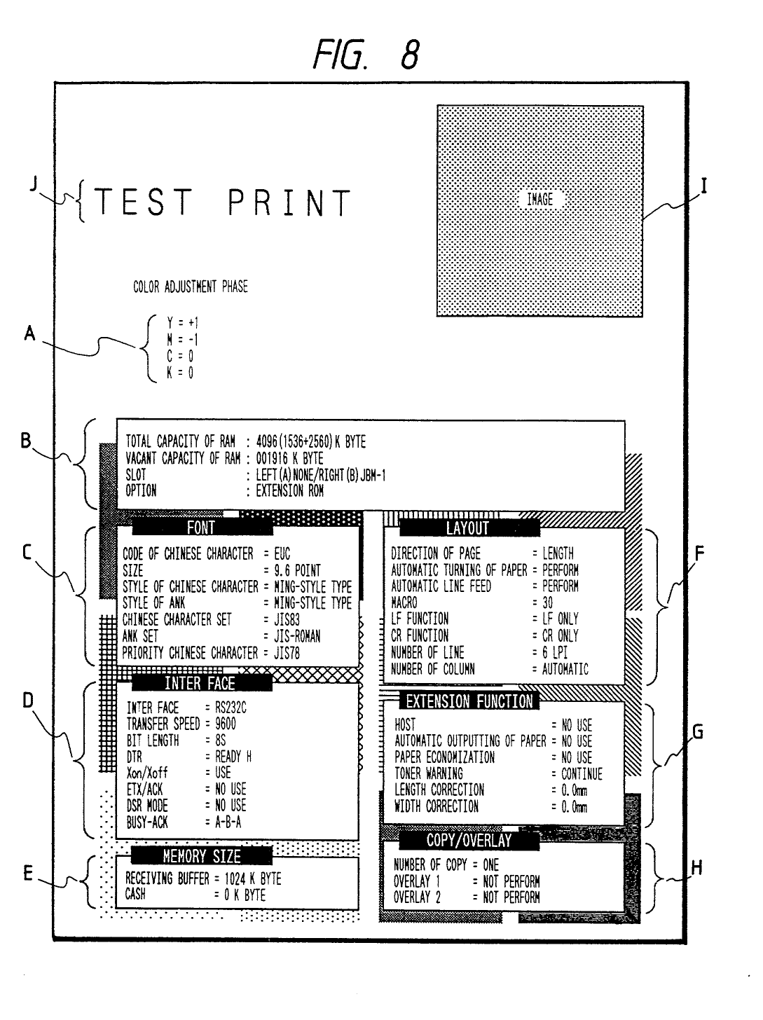

An example of a process of subjecting print data downloaded from the PC1 to predetermined image processing to generate binary data for printing will be described with reference to FIG. 8.

First, at step S81, input signals R, G, and B have their colors finely adjusted. This fine color adjustment corresponds to a brightness or contrast correction. Next, at step S82, a color matching process is executed. This process is executed to match the hues of colors expressed by a monitor (not shown in FIG. 1) used for the server PC 1 or the client PC 4 with those printed by the printer 2. Further, at step S83, a brightness-density conversion is executed. This process comprises converting the brightness signals R, G and B, which are input signals to the printer 2, into the density signals C, M, Y and K used by the printer 2.

Next, at step S84, an output γ correction is executed. That is, the γ correction table (correction function data) generated through the above described calibration depending on the output density characteristic of the present printer 2 is used to subject the density signals C, M, Y and K each comprising 8 bits to a γ correction, the 8 bits signals having been obtained at step S83.

After the above process, at step S85, a halftoning process is executed to convert each of the 8-bit signals into a 1-bit signal, which is suitable for the configuration of laser beams for the present printer 2. For a configuration in which laser beams system are capable of multilevel outputs, the 8-bit signals are converted into two or more values depending on the relevant level as is well known.

The calibration process of this embodiment and the image processing for printing executed by the printer 2 using the γ correction table renewed through the calibration process have been described with reference to FIGS. 1 to 8; the calibration and other processes are executed as application on the server PC1 according to this embodiment. The above-described calibration will be explained below in terms of user interfaces in the above applications.

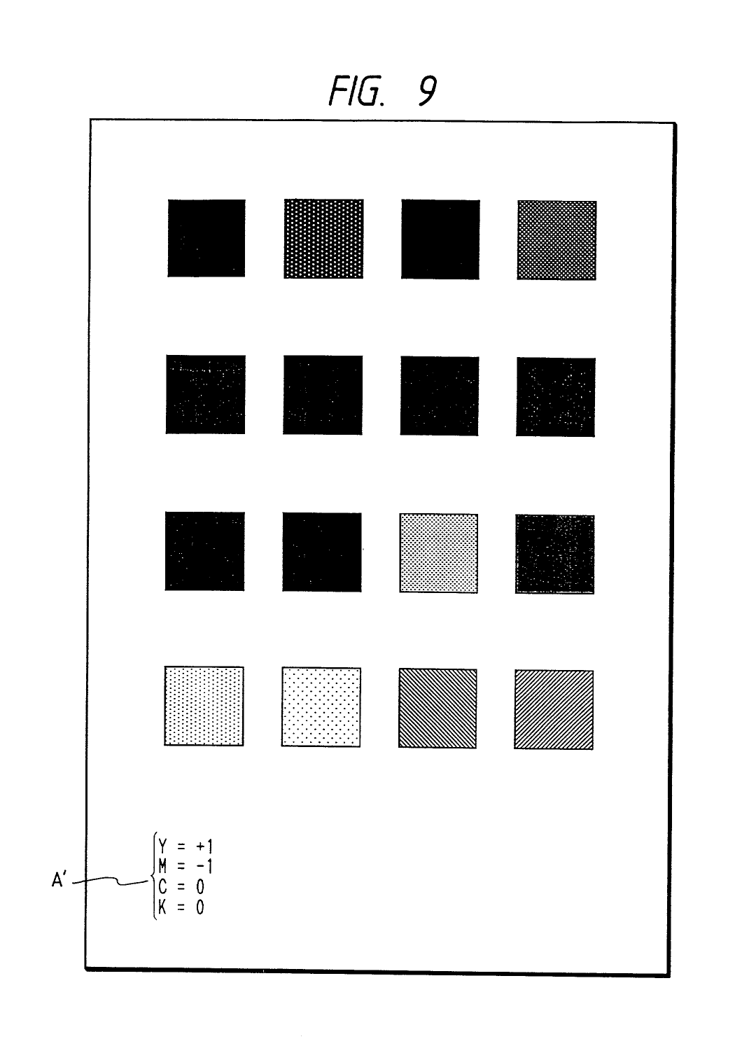

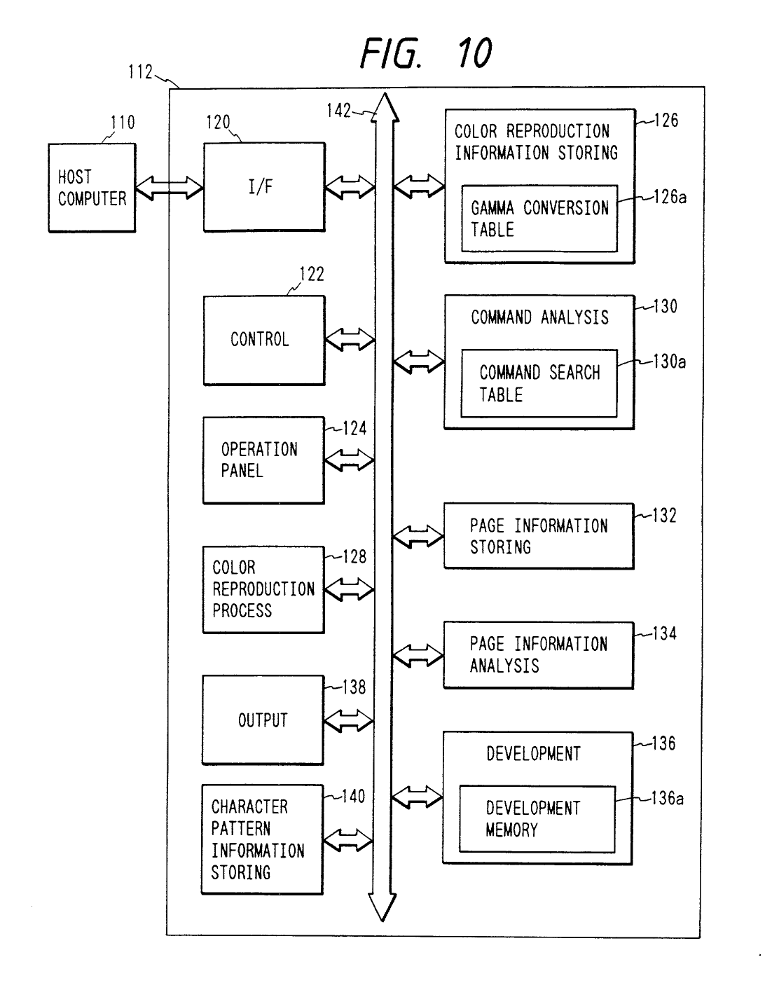

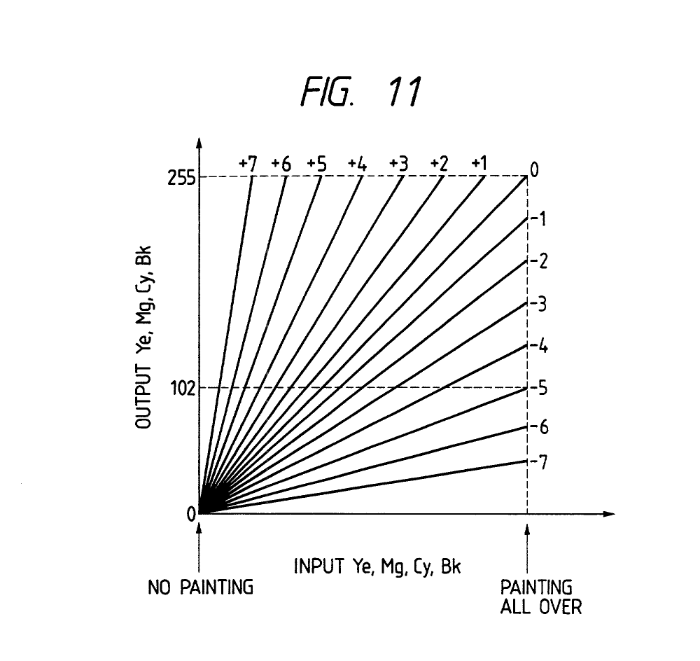

FIG. 9 is a diagram showing transitions of a process procedure for the calibration. FIG. 10 is a view useful in explaining a user interface used for this process procedure, showing a main screen as an example of a monitor display in the procedure.

At step S901 in FIG. 9, the main screen is displayed. As shown in FIG. 10, the main screen displays a selection menu including three types of menu items: “New”, “Open Measurement Data File”, and “Delete Download Data”. The display screen of the present user interface basically allows selection from “Next”, “Return”, “Cancel”, and “Help” to thereby move to another relevant screen.

In this main screen, when “New” is selected and the “Next” button is depressed, the procedure shifts to processing between steps S902 and S908. That is, the selection of “New” enables the user to instruct new calibration data to be generated.

More specifically, in response to this instruction, the process described previously from step S21 to step S24 is executed between steps S902 and S908. First, at step S902, patch data are output to the printer 2 specified for the calibration. The selection of the printer 2 for this process can be carried out by means of a predetermined operation via a screen displayed at step S902.

Next, at step S905, the scanner 3 is calibrated as described previously in FIG. 5. This provides the scanner with appropriate reading characteristics before the patch reading. Next, at step S907, when the user sets a sheet with a patch printed thereon in the scanner 3, the patch is read. Then, at step S908, the above-described calibration is carried out. This corresponds to the processing at steps S23 and S24, described previously in FIG. 2, that is, the generation of calibration data and the downloading of the data into the printer 2.

In this regard, at step S908, the monitor displays a button for shifting to processing at step S909 so that this button can be depressed to shift to the step S909. At step S909, the patch measurement data read at step S907 as well as the generated correction function can be saved.

After step S909, the procedure returns to the processing at step S908. A process completion screen is displayed at step S910, and when the user instructs this application to be ended the process is ended. When the user instructs keep on the process the process returns to the display of the main screen at step S901.

In the main screen at step S901, when “Open Measurement Data File” is selected and the “Next” button is depressed, a display is provided at step S903 to give an instruction for measurement data. Then, when a “Reference” button is depressed, the procedure shifts to step S906 to load the measurement data and the correction function to thereby display the result of the loading. This display enables the data obtained through measurements by the scanner 3 and the generated correction function to be examined in detail. Additionally, this embodiment allows the user to edit the saved correction function on the screen before saving it again. In this connection, the measurement data are described in the file saved at step S909. At step S908, the measurement data from the saved file, which have been displayed and examined, are used to generate the calibration table, which is then downloaded.

In addition, the user can check the measurement data to understand printing conditions in detail. This checking also allows the user to appropriately determine when to replace a drum or the like. Furthermore, the user can edit the correction function to finely adjust the data so as to appropriately express the colors.

In addition, in the main screen at step S901, when “Delete Download Data” is selected and the “Next” button is depressed, the calibration data stored in the calibration data storage section 21 of the printer 2 are deleted at step S904. This deletion is instructed through a command to the printer 2, but detailed description thereof is omitted.

Test printing of this embodiment for checking the effects of image corrections using the correction function data, that is, the calibration data obtained by the calibration described above with reference to FIGS. 1 to 11 will be explained below.

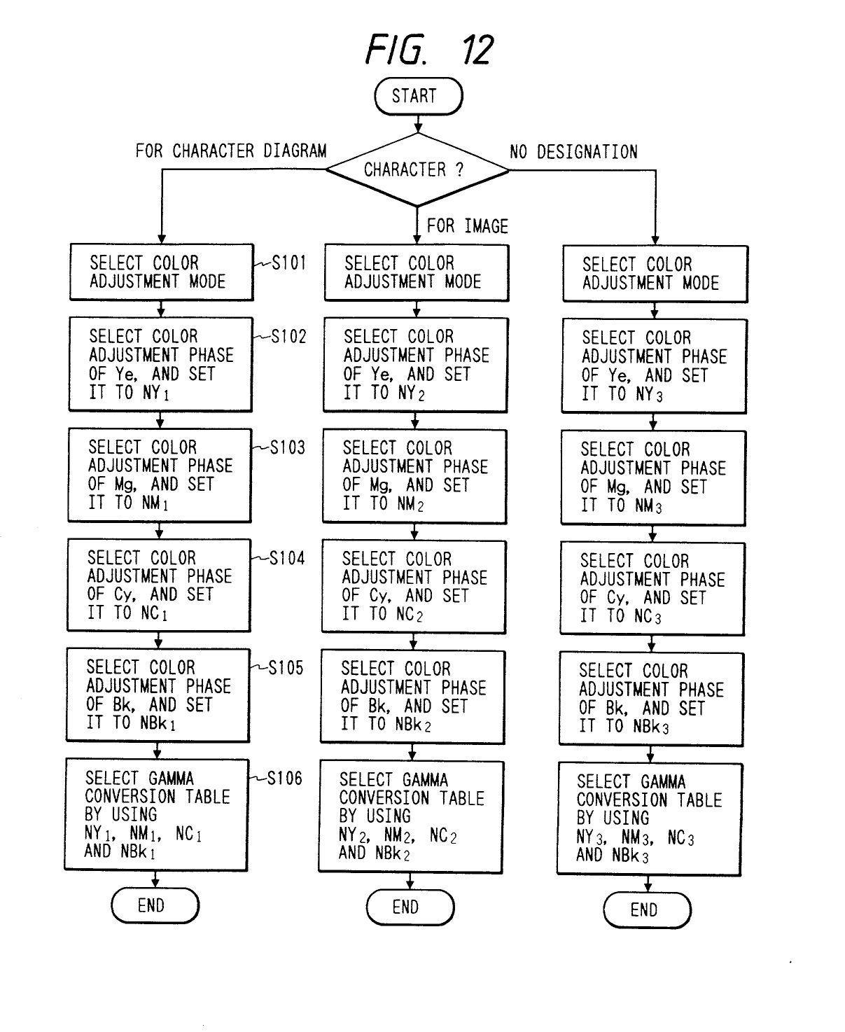

FIG. 12 is a block diagram showing a configuration of the printing system of this embodiment shown in FIG. 1 wherein the test printing is executed. That is, the test printing of this embodiment is executed by the printer 2 based on an instruction given by the user at the server PC 1. The server PC 1 has a user interface 101 (hereafter simply referred to as “UI”) comprising a display device and an input equipment such as, a mouse, and a keyboard. The user can give instructions for the test printing via the UI101.

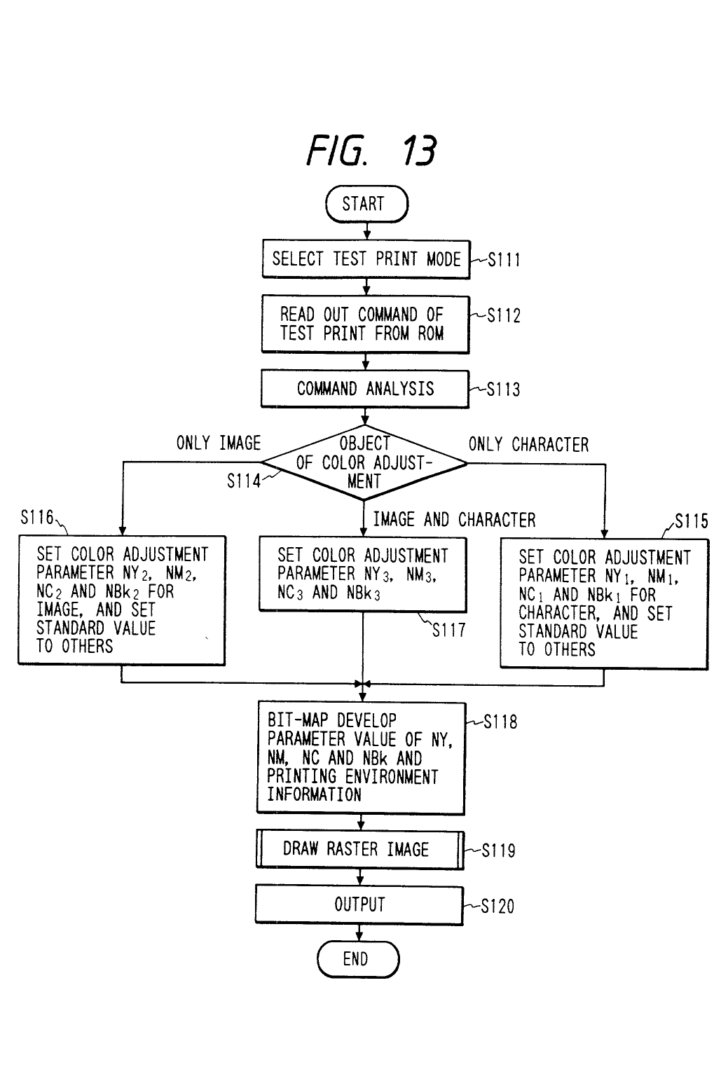

A CPU 104 executes not only the above described processes for the server PC1 but also a process for the test printing, described later in FIG. 13. A sample image memory 102 stores test printing images used for the test printing process, and a correction function memory 105 stores the patch measurement data and the generated correction function as explained for the above described step S909. A memory 103 is principally used as a work area during the processes executed by the CPU 104.

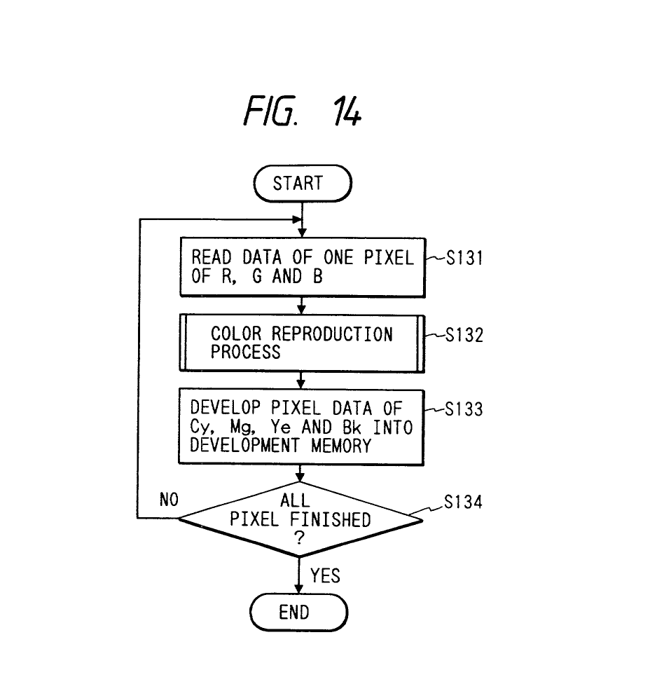

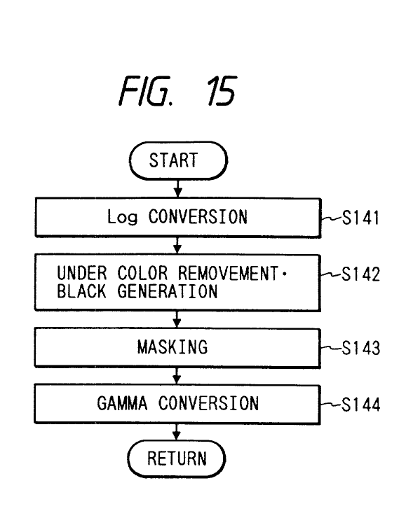

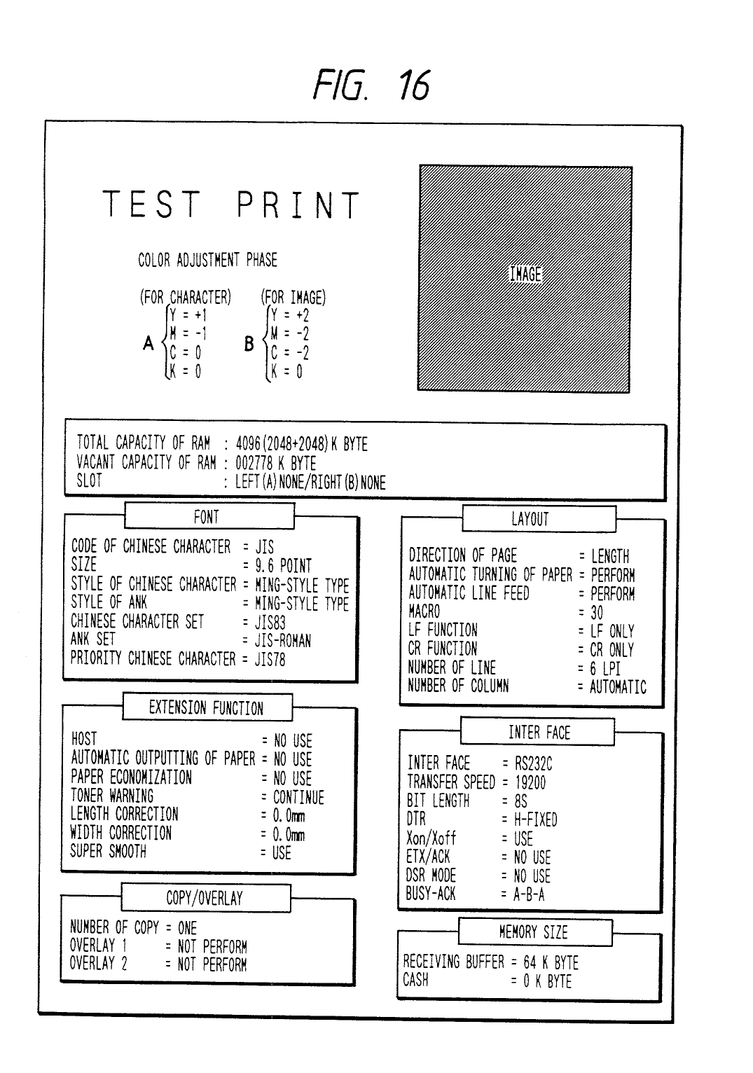

FIG. 13 is a flow chart showing a process for the test printing of this embodiment, and FIG. 14 is a view showing a UI display screen displayed during the test printing.

When the test printing is to be executed, the UI screen shown in FIG. 14 is displayed. Then, depressing a Print Sample button 122 in the screen causes the process shown in FIG. 13 to be started. A correction function curve (calibration curve) 121 in the UI display screen schematically shows, for each of C, M, Y, and K, the contents of a γ correction table stored in the correction function memory 105 (see FIG. 12) at time when the test printing is executed. This display serves to allow the test printing to be carried out while checking the results of calibration or a subsequently edited correction function.

Once the test printing process shown in FIG. 13 has been started, the CPU 104 applies a γ correction to a predetermined test pattern image stored in the sample image memory 102 using the γ correction table stored in the correction function memory 105. The CPU 104 then transmits the corrected test pattern image to the printer 2, which then prints the predetermined test pattern.

In this case, the server PC1 instructs the printer 2 to avoid executing the γ correction inside the printer.

Next, at step S102, the state of a switch 123 in the UI screen shown in FIG. 14 is checked, the switch 123 being used to indicate whether or not to print only an image based on γ-corrected test pattern data. If the switch 123 has been activated (on state), that is, it is determined that only the γ-corrected test pattern is to be printed, this process is ended.

On the other hand, if it is determined that the switch 123 has been deactivated (off state), that is, an image based on non-γ-corrected test pattern data is to be printed, the test pattern data stored in the sample image memory 102 is directly output to the printer 2, which then prints a test pattern based on the non-γ-corrected data.

According to the above test pattern printing method, the user has only to operate the switches in the UI screen to print the corrected test pattern while setting whether printing a non-corrected test pattern (also referred “comparison test pattern”) or not. Consequently, this makes it possible to select either printing of only the corrected test pattern or printing of both corrected and non-corrected test patterns through a simple operation.

<Second Embodiment>

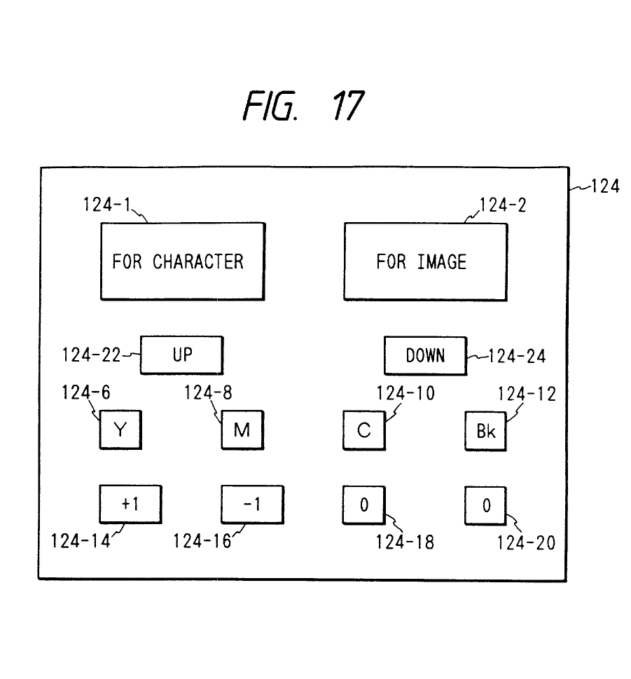

This embodiment further simplifies the user's setting for the test printing. FIG. 15 is a flow chart showing a process for test printing of this embodiment.

The process shown in FIG. 15 differs from the process according to the above-described Embodiment 1 which is shown in FIG. 13, only in the processing at step S204. At step S204, after a non-corrected test pattern has been printed (step S203), the switch 123 (see FIG. 14) for allowing the user to set the test printing to print only the corrected test pattern is activated.

Thus, this switch 123 is automatically activated after the non-corrected test pattern has been printed once, so that if only the corrected test pattern is to be printed during the next test pattern printing, the user need not operate the switch 123. Consequently, if only one non-corrected test pattern is printed for comparison, while the corrected test pattern is printed, for example, whenever the correction function is changed, in order to check the effects of this change, this embodiment further facilitates the user's operations.

<Third Embodiment>

According to further embodiment of the present invention, in changing the correction function in order to edit the calibration data, the user can execute the process more easily.

Specifically, when an edition button 124 in the UI screen is depressed to edit the calibration data, the switch 123 for allowing the user to set the test printing to print only a corrected test pattern is automatically activated as shown in FIG. 16. According to this embodiment, if edition of the calibration data and checking of the effects thereof are repeated, only the corrected test pattern is printed to appropriately prevent a non-corrected test pattern from being wastefully printed.

The above embodiments each have been described in conjunction with the example where the UI screen has the switch for allowing the user, by ON state of the switch, to set the test printing to print a corrected test pattern only and, by OFF state of the switch, to print both the corrected and a non-corrected test patterns, but it is apparent that the present invention is applicable based on a relationship opposite to that in the above described embodiment if a meaning of ON and OFF state of the switch is exchanged.

<Other Embodiments>

As described above, the present invention is applicable either to a system comprising plural pieces of device (such as a host computer, interface device, a reader, and a printer, for example) or to an apparatus comprising one piece of device (for example, a copy machine or facsimile terminal device).

Additionally, an embodiment is also included in the category of the present invention, wherein program codes of software such as those shown in FIGS. 13 and 15, for example, which realize the above described embodiments, are supplied to a computer in an apparatus or a system connected to various devices to operate these devices so as to implement the functions of the above described embodiments, so that the various devices are operated in accordance with the programs stored in the computer (CPU or MPU) of the system or apparatus.

In this case, the program codes of the software themselves implement the functions of the above described embodiments, so that the program codes themselves and means for supplying them to the computer, for example, a storage medium storing such program codes constitute the present invention.

The storage medium storing such program codes may be, for example, a floppy disk, a hard disk, an optical disk, a magneto-optical disk, a CD-ROM, a magnetic tape, a non-volatile memory card, or a ROM.

In addition, if the functions of the above described embodiments are implemented not only by the computer by executing the supplied program codes but also through cooperation between the program codes and an OS (Operating System) running in the computer, another application software, or the like, then these program codes are of course embraced in the embodiments of the present invention.

Furthermore, a case is of course embraced in the present invention, where after the supplied program codes have been stored in a memory provided in an expanded board in the computer or an expanded unit connected to the computer, a CPU or the like provided in the expanded board or expanded unit executes part or all of the actual process based on instructions in the program codes, thereby implementing the functions of the above described embodiments.

As is apparent from the above description, each embodiment of the present invention provides a configuration capable of printing a test pattern and a comparison test pattern therefor, when the test pattern is to be printed, it can be judged whether or not to also print the comparison test pattern, thereby making it possible to determine to print the comparison test pattern or determine not to print it depending on the result of the judgement. Accordingly, if the above judgement is made depending on a user's operation input, it enables the user to set the test printing to print either only the test pattern or both the test pattern and the comparison test pattern therefor.

As a result, in test printing for a printing system which enables the comparison test pattern to be simultaneously printed, printing of the comparison test pattern can be easily set.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A test printing method capable of printing a test pattern and a comparison test pattern with which the test pattern is compared, said method comprising the steps of:
printing the test pattern;
judging whether or not printing the comparison test pattern; and
when said judgement is what to print the comparison test pattern, printing said comparison test pattern.

2. A test printing method as claimed in claim 1, wherein said step of judging whether or not printing the comparison test pattern based on a state of an input by an operation of a user.

3. A test printing method as claimed in claim 2, wherein the input is an input through a switch which can be operated so that setting is made to print only the test pattern or to print the test pattern and the comparison test pattern.

4. A test printing method as claimed in claim 3, further comprising the step for printing the comparison test pattern as well as making the switch operated so that setting is made to print only the test pattern, when said step of judging that the switch is operated so that setting is made to print the test pattern and the comparison test pattern.

5. A test printing method as claimed in claim 2, wherein the input is an input through a switch which can be operated in connection with other predetermined operation input, so that setting is made to print only the test pattern or to print the test pattern and the comparison test pattern.

6. A test printing method as claimed in claim 1, wherein the test pattern is printed based on corrected data and the comparison test pattern is printed based on non-corrected data.

7. A test printing method as claimed in claim 1, wherein the test pattern and the comparison test pattern are printed in connection with a calibration for a printing apparatus.

8. An information processing apparatus capable of causing a printing apparatus to print a test pattern and a comparison test pattern with which the test pattern is compared, said information processing apparatus executing a process comprising the steps of:
causing the printing apparatus to print the test pattern;
judging whether or not printing the comparison test pattern; and
when said judgement is what to print the comparison test pattern, causing the printing apparatus to print said comparison test pattern.

9. An information processing apparatus as claimed in claim 8, comprising a user interface and wherein said step of judging whether or not printing the comparison test pattern based on a state of an input by an operation of a user through the user interface.

10. An information processing apparatus as claimed in claim 8, wherein the input is an input through a switch which can be operated so that setting is made to print only the test pattern or to print the test pattern and the comparison test pattern.

11. A printing system capable of printing a test pattern and a comparison test pattern with which the test pattern is compared when executing a test printing, wherein a process including the steps of:
printing the test pattern;
judging whether or not printing the comparison test pattern; and
when said judgement is what to print the comparison test pattern, printing said comparison test pattern is executed.

12. A printing system as claimed in claim 11, comprising a user interface and wherein said step of judging whether or not printing the comparison test pattern based on a state of an input by an operation of a user through the user interface.

13. A printing system as claimed in claim 12, wherein the input is an input through a switch which can be operated so that setting is made to print only the test pattern or to print the test pattern and the comparison test pattern.

14. A printing system as claimed in claim 13, wherein a process including the step for printing the comparison test pattern as well as making the switch operated so that setting is made to print only the test pattern is further executed, when said step of judging judges that the switch is operated so that setting is made to print the test pattern and the comparison test pattern.

15. A printing system as claimed in claim 12, wherein the input is an input through a switch which can be operated in connection with other predetermined operation input, so that setting is made to print only the test pattern or to print the test pattern and the comparison test pattern.

16. A printing system as claimed in claim 11, wherein the test pattern is printed based on corrected data and the comparison test pattern is printed based on non-corrected data.

17. A printing system as claimed in claim 11, wherein the test pattern and the comparison test pattern are printed in connection with a calibration for a printing apparatus.

18. A program comprising program code means causing an information processing apparatus to execute a test printing process capable of printing a test pattern and a comparison test pattern with which the test pattern is compared, wherein said test printing process including the steps of:
printing the test pattern;
judging whether or not printing the comparison test pattern; and
when said judgement is what to print the comparison test pattern, printing said comparison test pattern.

19. A storage medium storing a program capable of being read by an information processing apparatus, wherein a process of the program capable of printing a test pattern and a comparison test pattern with which the test pattern is compared, said process comprising the steps of:
printing the test pattern;
judging whether or not printing the comparison test pattern; and
when said judgement is what to print the comparison test pattern, printing said comparison test pattern.
